(19) United States
(12) Patent Application Publication
(10) Pub. No.: US 2024/0315295 A1
(43) Pub. Date: Sep. 26, 2024

(54) FUNCTIONAL POTATO PROTEIN COMPOSITIONS WITH REDUCED ENZYMATIC ACTIVITY

(71) Applicant: Coöperatie Koninklijke Cosun U.A., Breda (NL)

(72) Inventors: Maria Jacoba Cornelia Van Gurp, Dinteloord (NL); Myrte Elisabeth Van der Heijden, Dinteloord (NL); Dimphna Johanna Heshof, Dinteloord (NL); Robert Vreeker, Dinteloord (NL); Michaël Johannes Jacobus Litjens, Dinteloord (NL); Allan Otto Fog Lihme, Farum (DK); Bodil Kjær Lindved, Espergærde (DK); Marie Bendix Hansen, Frederiksberg (DK); Rick Adrianus Petrus Jordens, Balgoij (NL)

(73) Assignee: Coöperatie Koninklijke Cosun U.A., Breda (NL)

(21) Appl. No.: 18/572,289

(22) PCT Filed: Dec. 22, 2021
(86) PCT No.: PCT/EP2021/087375

§ 371 Date: Dec. 20, 2023

(30) Foreign Application Priority Data
Jun. 23, 2021 (WO) PCT/EP2021/067206
Jun. 23, 2021 (WO) PCT/EP2021/067207
Jun. 23, 2021 (WO) PCT/EP2021/067210

(51) Int. Cl. A23L 19/12; A23J 3/14; A23J 3/22

(52) U.S. Cl. CPC A23L 19/12; A23J 3/14; A23J 3/22

(57) ABSTRACT

The present invention concerns a potato protein composition comprising:
patatin; and
optionally insoluble fibers from potato and/or other potato proteins,
   wherein the protein, preferably the potato protein, has an aqueous solubility at pH=7.0 and 20° C. of at least 60%, and
   wherein the composition has an acetylcholinesterase (ACE) activity of less than 30 U/g, based on the dry weight of the protein, preferably the potato protein.

The present invention further concerns a composition comprising fat or oil comprising at least one fatty acid group having 14 carbon atoms or less, and the said potato protein composition.

### FIELD OF THE INVENTION

The invention relates to a potato protein composition with reduced enzymatic activity, to a composition comprising fat or oil and said potato protein composition and to a food product comprising said potato protein composition or said composition comprising fat or oil and said potato protein composition. The invention further relates to a method of reducing the enzymatic activity of a potato protein composition and to the potato protein composition obtainable by said method.

### BACKGROUND OF THE INVENTION

Few nutrients are as important as protein in the human diet. Proteins are the main building blocks of the human body. They are used to make muscles, tendons, organs, and skin, as well as enzymes, hormones, neurotransmitters and various other molecules that serve many important functions. Proteins are made up of amino acids as building blocks. The human body produces some of these amino acids, but other amino acids, known as essential amino acids, must be obtained via the diet. Generally, animal-derived protein provides all essential amino acids in the right ratio. Accordingly, meat and fish are important source of proteins for human consumption.

However, the world's increased meat and fish consumption goes hand in hand with long-term sustainability issues, because it is known to have a negative environmental impact and puts increased pressure on scarce resources. See in this respect for example H. Dagevos and J. Voordouw, Sustainability and meat consumption: is reduction realistic?, Sustainability: Science, Practice and Policy, 9(2), Summer 2013, pp 60-69.

Proteins from plant material could potentially form a major protein source for food applications. Significant research efforts have thus been dedicated to developing techniques for the isolation of plant-based proteins and to developing new products based on plant-based proteins, such as food products that are organoleptically similar to meat or fish. Such products preferably also have protein contents similar to that of meat or fish.

A promising candidate is potato protein. The potato (Solanum tuberosum L.) is a tuber that is used as food or in food applications and is a source of different bioactive compounds, such as starch, dietary fibers, amino acids, minerals, vitamins, glycoalkaloid compounds and phenolic compounds.

In the starch manufacturing industry, starch is separated from potatoes, resulting in high volumes of so-called potato fruit juice (PFJ). Potato fruit juice is a complex mixture of soluble and insoluble material comprising potato proteins, minerals, (toxic) glycoalkaloids, (insoluble) fibers and monomeric and polymeric reactive phenols. The potato proteins can be isolated and/or purified and can be applied in new food products. The larger part of proteins present in potato and in potato fruit juice consists of patatin and protease inhibitors.

Native/soluble or at least partially native/soluble patatin and/or protease inhibitor proteins, i.e. not fully denatured or coagulated potato proteins, may be used as techno-functional ingredients in the preparation of foodstuffs, for example to provide (thermo)gelling, foaming, water-binding and/or emulsification properties. For these purposes, the potato proteins preferably are devoid of compounds that may give rise to unwanted color and taste formation and/or influence the quality and stability of the prepared food in a negative way.

Sufficient (thermo)gelling behavior of proteins is of particular importance when the protein is used in food products as a binding agent for different ingredients.

It is an object of the invention to provide novel potato protein compositions for use in the preparation of food products, particularly for use in the preparation of plant-based, vegetarian or vegan food products.

It is a further object of the invention to provide novel potato protein compositions that can be used as binding or gelling agent in food products and that do not give rise to unwanted taste formation and/or do not influence the quality and stability of the prepared food in a negative way.

It is a still further object of the invention to provide novel food products, particularly plant-based, vegetarian or vegan food products, comprising said novel potato protein compositions.

### SUMMARY OF THE INVENTION

The inventors have established that patatin in patatin-containing protein compositions obtained from potato fruit juice may have considerable lipolytic acyl hydrolase (LAH) activity. When such patatin-containing protein compositions are used in food products along with fats and/or oils comprising glycerol esters of fatty acids having 14 carbon atoms or less, the LAH activity of patatin results in the formation of free fatty acids having 14 carbon atoms or less. These free fatty acids adversely affect the quality of the food product. More in particular, these free fatty acids give rise to unwanted taste formation, such as a strong off flavor which can generally not be masked by adding flavoring agents.

The enzymatic activity of patatin can be irreversibly eliminated by thermal coagulation. However, such thermal coagulation also adversely affects the techno-functional properties of the patatin in an irreversible way.

The inventors have unexpectedly found that treating patatin-containing protein compositions under certain acidic conditions results in protein compositions having both sufficient techno-functional properties, such as aqueous solubility and thermal gelling behavior, and a sufficiently low LAH activity. As a result, these treated patatin-containing protein compositions can be applied as binding or gelling agents in food products, such a meat or fish substitutes, without adversely affecting the taste. At the claimed acetylcholinesterase (ACE) activity levels, there may exist an off flavour in food products comprising patatin-containing protein compositions and fat/oil comprising glycerol esters of fatty acids having 14 carbon atoms or less, which off flavour is, however, considerably less than the off flavour obtained with patatin-containing protein compositions not in accordance with the invention. The off flavour may be masked when flavouring agents are added to the food product. By reducing the ACE activity of the inventive protein composition to below 5 U/g protein, no off flavors are generally observed.

The low LAH activity of the potato protein compositions can be represented by a maximum ACE activity. In the context of the present description, the ACE activity is taken as a measure of the enzymatic activity of the potato protein composition. The ACE activity is measured with the spectrophotometric assay as defined in the experimental section. In this respect, reference is made to R. B. Miller et al., A Rapid Spectrometric Method for the Determination of Esterase Activity, Journal of Biochemical and Biophysical Methods, 3 (1980), pp 345-354, which is incorporated herein by reference. This spectrophotometric assay records esterase activity and can therefore also be used to determine the LAH activity of patatin.

The techno-functional properties of the potato protein compositions can be expressed in a minimum aqueous solubility at pH=7.0 and at a temperature of 20° C. and/or a minimum gel strength at a temperature of 20° C., defined as the storage modulus G′. The aqueous solubility and gel strength are measured with the protocols as defined in the experimental section.

Accordingly, in a first aspect, the invention provides a potato protein composition comprising:
patatin; and
optionally insoluble fibers from potato and/or other potato proteins,
   wherein the protein, preferably the potato protein, has an aqueous solubility at pH=7.0 and 20° C. of at least 60%, and wherein the composition has an acetylcholinesterase (ACE) activity of less than 30 U/g, based on the dry weight of the protein, preferably the potato protein. In the context of this application, the terms “solubility” or “aqueous solubility” refer to the solubility at a pH of 7 and a temperature of 20° C. as measured using the method described in the experimental section of this application.

In a second aspect, the invention provides a composition comprising a fat or oil comprising at least one fatty acid group having 14 carbon atoms or less, and a potato protein composition as defined herein.

In a third aspect, the invention provides a food product comprising the potato protein composition as defined herein or the composition comprising fat or oil as defined herein.

In a fourth aspect, the invention provides a method of reducing the lipolytic acyl hydrolase (LAH) activity of a potato protein composition, said composition comprising:
patatin; and
optionally insoluble fibers from potato and/or other potato proteins;
   said method comprising the steps of:
(a) providing the potato protein composition wherein the protein preferably the potato protein, has an aqueous solubility at pH=7.0 and 20° C. of at least 60% and wherein the composition has an acetylcholinesterase (ACE) activity of more than 30 U/g, based on the dry weight of the protein, preferably the potato protein;
(b) subjecting the potato protein composition provided in step (a) to a pH below 4.5 at a temperature below 50° C.;
(c) optionally raising the pH of the potato protein composition obtained in step (b) to a value between 5 and 10;
(d) optionally drying, preferably spray drying, the potato protein composition obtained in step (b) or (c).

In a fifth aspect, the invention provides a potato protein composition, wherein the protein, preferably the potato protein, has an aqueous solubility at pH of 7.0 and 20° C. of at least 60%, and
wherein the composition has an acetylcholinesterase (ACE) activity of less than 30 U/g, based on the dry weight of the protein, preferably the potato protein,
obtainable with the method of reducing the ACE activity as defined herein, wherein step (c) is mandatory.

### Definitions

The term ‘techno-functional proteins’ means proteins that (still) have a high level of their intrinsic techno-functional properties, such as aqueous solubility and the ability to form gels when heated in solution (thermo-gelling), and preferably the ability to create foams when aqueous solutions of the protein are whipped with air, and the ability to create emulsions when mixed with lipids in aqueous solutions of the protein. The term ‘techno-functional proteins’ as used herein is therefore considered similar to the terms ‘soluble proteins’, ‘(substantially) native proteins’ and ‘(substantially) undenatured proteins’ as used in the art.

The term ‘insoluble fibers’, also denoted herein as ‘FI’, means substances present in the potato fruit juice or in the derivatives thereof that can be separated from the liquid phase by centrifugation in a laboratory centrifuge at 4000 rpm for 30 minutes at room temperature. The precise chemical composition of the insoluble fibers may vary broadly, but may typically comprise insoluble polysaccharides, pectinates, starches and proteins and insoluble complexes of one or more of these substances. The amount of insoluble fibers is determined using AOAC Official Method 2011.25 ‘Insoluble, Soluble, and Total Dietary Fiber in Foods’.

The term ‘patatin’, also denoted herein as ‘PA’, means storage glycoproteins found in potatoes (Solanum tuberosum L.). Patatin represents a group of immunologically identical glycoprotein isoforms with molecular masses in the range of 40-43 kDa. Patatin also has phospolipase activity capable of cleaving fatty acids from membrane lipids. For purposes of the invention, PA may be determined by HPLC-GPC (see the measuring protocol in the experimental section).

The term ‘protease inhibitor’, also denoted herein as ‘PI’, means potato proteins, which possess molecular weights ranging from about 3 kDa to about 35 kDa, and which are capable of inhibiting the activity of e.g. serine proteases, cysteine proteases, aspartate proteases, and metalloproteases. For purposes of the invention PI may be determined by HPLC-GPC (see the measuring protocol in the experimental section).

The term ‘glycoalkaloids’ or ‘alkaloid glucosides’ means a family of potentially toxic chemical compounds derived from alkaloids to which sugar groups are attached. Prototypical glycoalkaloids present in potatoes (Solanum tuberosum L.) are α-solanine and α-chaconine. In the context of the present disclosure, the level of ‘total glycoalkaloids’ is expressed as the sum of α-solanine and α-chaconine. For purposes of the invention, glycoalkaloids may be determined by LC-MS (see the measuring protocol in the experimental section).

The term ‘phenolic compounds’ means aromatic or heteroaromatic compounds comprising one or more ring systems and one or more phenolic hydroxyl groups. Phenolic compounds from potatoes include phenolic acids, flavonoids, tannins, stilbenes and lignans.

The term ‘dry weight’ as used in the context of the present invention means the weight or mass of a substance remaining after removal of water by heating at 110° C. until the weight does not change anymore.

The term ‘polyphenol oxidase’, also denoted herein as ‘PPO’, means in the context of the present invention potato protein. Polyphenol oxidase (tyrosinase) (TY) is a bifunctional, copper-containing oxidase having both catecholase and cresolase activity. PPO causes the rapid polymerization of o-quinones to produce black, brown or red pigments (polyphenols) which cause fruit browning. The amino acid tyrosine contains a single phenolic ring that may be oxidised by the action of PPOs to form o-quinone. Hence, PPOs may also be referred to as tyrosinases. The catalytic action of PPO has a negative impact on the quality of several fruit and vegetable crops and results in alteration of color, flavor, texture, and nutritional value. It is a limiting factor in the handling and technological processing of crops as peeled, sliced, bruised or diseased tissues rapidly undergo browning. For purposes of the invention, PPO may be determined by HPLC-GPC (see the measuring protocol in the experimental section).

The term ‘lipoxygenase’, also denoted herein as ‘LipO’, means in the context of the present invention potato proteins capable of catalyzing the dioxygenation of polyunsaturated fatty acids. Lipoxygenases have food-related applications in bread making and aroma production but they also have negative implications for the color, off-flavour and antioxidant status of plant-based foods. In potatoes (Solanum tuberosum L.), lipoxygenase has a molecular weight of approximately 97 kD and can be detected by SDS-PAGE (see e.g. G. Bauw et al., Patatins, Kunitz protease inhibitors and other major proteins in tuber of potato cv. Kuras, FEBS Journal, 2006, 273, pp 3569-3584). For purposes of the invention LipO may be determined by HPLC-GPC (see the measuring protocol in the experimental section).

The term ‘diafiltration’ in the context of the present invention means a technique that uses membranes, typically ultrafiltration membranes, to completely remove, replace, or lower the concentration of salts or other low molecular weight substances from solutions containing proteins, peptides, nucleic acids, and other high molecular weight molecules. The process selectively utilizes permeable (porous) membrane filters to separate the components of solutions and suspensions based on their molecular size. An ultrafiltration membrane retains molecules that are larger than the pores of the membrane, while smaller molecules such as salts, polyphenols, solvents and water, may pass through the membrane. In a diafiltration process, water or a buffer composition (i.e. the diafiltration liquid) is continuously added to the retentate while the membrane filtration process continuously removes water, salts and low molecular weight compounds to the permeate side of the membrane.

The term ‘ultrafiltration’ means a variety of membrane filtration processes in which forces like pressure or concentration gradients lead to a separation through a semipermeable membrane. Suspended solids and solutes of high molecular weight are retained in the so-called retentate, while water and low molecular weight solutes pass through the membrane in the permeate (filtrate). Ultrafiltration membranes are defined by the pore size or by the molecular weight cut-off (MWCO) of the membrane used. Ultrafiltration membranes typically have a pore size of 0.01-0.1 μm or a molecular weight cut-off of between 1 and 500 kDa, such as between 5 and 50 kDa. Ultrafiltration is applied in cross-flow or dead-end mode. In a continuous process, ultrafiltration is applied in cross-flow mode.

The term ‘comprise’ and ‘include’ as used throughout the specification and the accompanying items/claims as well as variations such as ‘comprises’, ‘comprising’, ‘includes’ and ‘including’ are to be interpreted inclusively. These words are intended to convey the possible inclusion of other elements or integers not specifically recited, where the context allows, unless specified otherwise.

The articles ‘a’ and ‘an’ are used herein to refer to one or to more than one (i.e. to one or at least one) of the grammatical object of the article. By way of example, ‘an element’ may mean one element or more than one element, unless specified otherwise.

### BRIEF DESCRIPTION OF THE FIGURE

FIG. 1 depicts esterase activity in potato protein compositions that were treated at different pH-values and temperatures using a process according to the invention.

### DETAILED DESCRIPTION

### Potato Protein Composition

In a first aspect, the invention concerns a potato protein composition comprising:
patatin; and
optionally insoluble fibers from potato and/or other potato proteins,
   wherein the protein, preferably the potato protein, has an aqueous solubility at pH=7.0 and 20° C. of at least 60%, and
   wherein the composition has an acetylcholinesterase (ACE) activity of less than 30 U/g, based on the dry weight of the protein, preferably the potato protein.

As is known to the skilled person, patatin is a potato protein. Other potato proteins that may be present in the potato protein composition include protease inhibitors, polyphenol oxidases and lipoxygenases. Polyphenol oxidase and lipoxygenases are typically potato proteins having a molecular weight above 100 kDa.

In an embodiment, the potato protein composition comprises at least 10 wt. % protein, preferably at least 30 wt. %, more preferably at least 50 wt. %, and most preferably at least 60 wt. %, based on the dry weight of the composition, and preferably at most 99 wt. % protein, more preferably at most 98 wt. % and most preferably at most 95 wt. %, based on the dry weight of the composition. The total protein content includes potato proteins and may also comprise other proteins not comprised in potato. The weight percentage of protein, based on the dry weight of the potato protein composition, can for example be determined with the Kjeldahl method.

In an embodiment, preferably when the potato protein composition comprises only potato proteins, the potato protein composition of the invention comprises at least 10 wt. % potato protein, preferably at least 25 wt. %, more preferably at least 30 wt. %, even more preferably at least 35 wt. %, even more preferably at least 40 wt. %, even more preferably at least 45 wt. %, even more preferably at least 50 wt. %, even more preferably at least 55 wt. % and most preferably at least 60 wt. %, based on the dry weight of the composition, and preferably at most 99 wt. % potato protein, more preferably at most 98 wt. % and most preferably at most 95 wt,%, based on the dry weight of the composition. The weight percentage of potato protein, based on the dry weight of the potato protein composition, can for example be determined with the Kjeldahl method.

In a further embodiment, the potato protein composition comprises at least 5 wt. % patatin, preferably at least 10 wt. %, more preferably at least 15 wt. %, even more preferably at least 20 wt. %, even more preferably at least 25 wt. %, even more preferably at least 30 wt. %, even more preferably at least 35 wt. %, even more preferably at least 40 wt. %, even more preferably at least 45 wt. %, and most preferably at least 50 wt. %, based on the dry weight of the composition, and preferably at most 99 wt. % patatin, more preferably at most 90 wt. %, even more preferably at most 80 wt. % and most preferably at most 70 wt. %, based on the dry weight of the composition. Preferably, the patatin present in the potato protein composition of the invention is at least partially deactivated as regards LAH activity.

In a further embodiment, the potato protein composition comprises at least 10 wt. % protease inhibitors, preferably at least 20 wt. %, more preferably at least 30 wt. % and most preferably at least 40 wt. %, based on the dry weight of the composition, and preferably at most 99 wt. % protease inhibitors, more preferably at most 90 wt. %, even more preferably at most 80 wt. % and most preferably at most 70 wt. %, based on the dry weight of the composition.

In an embodiment, the potato protein composition comprises both patatin and protease inhibitors. In a preferred embodiment, the potato protein composition comprises at least 5 wt. % of patatin and at least 5 wt. % of protease inhibitors, based on the dry weight of the composition, at least 10 wt. % of patatin and at least 10 wt. % of protease inhibitors, at least 15 wt. % of patatin and at least 15 wt. % of protease inhibitors, or at least 20 wt. % of patatin and at least 20 wt. % of protease inhibitors.

Preferably, the weight ratio of patatin to protease inhibitors in the potato protein composition is at least 0.01:1, more preferably at least 0.1:1, even more preferably at least 0.5:1 and most preferably at least 1:1, and preferably at most 100:1, more preferably at most 10:1, more preferably at most 5:1 and most preferably at most 2:1.

In a further embodiment, the potato protein composition comprises at least 0.01 wt. % potato proteins having a molecular weight above 100 kDa, preferably at least 0.1 wt. %, more preferably at least 0.5 wt. % and most preferably at least 1 wt. %, based on the dry weight of the composition, and preferably at most 40 wt. % potato proteins having a molecular weight above 100 kDa, more preferably at most 30 wt. %, even more preferably at most 25 wt. % and most preferably at most 20 wt. %, based on the dry weight of the composition.

In a further embodiment, the potato protein composition comprises at least 0.4 wt. % insoluble fibers, preferably at least 0.5 wt. %, more preferably at least 1 wt. % and most preferably at least 1.5 wt. %, based on the dry weight of the composition, and preferably at most 20 wt. % insoluble fibers, more preferably at most 15 wt. %, even more preferably at most 10 wt. % and most preferably at most 5 wt. %, based on the dry weight of the composition. Also potato protein compositions of the invention which do not comprise insoluble fibers are contemplated.

In a preferred embodiment, the protein, preferably the potato protein, has an aqueous solubility at pH=7.0 and 20° C. of at least 65%, more preferably at least 70%, even more preferably at least 75%, still more preferably at least 80%, yet more preferably at least 85%, and preferably at most 99%, such as at most 98%, or at most 95%.

In another preferred embodiment, the potato protein composition has an acetylcholinesterase (ACE) activity of at most 20 U/g, more preferably at most 10 U/g, most preferably at most 5 U/g, based on the dry weight of the protein, preferably the potato protein, and preferably at least 0.01 U/g, more preferably at least 0.05 U/g, and most preferably at least 0.1 U/g, based on the dry weight of the protein, preferably the potato protein. When the ACE activity is lower, the off taste in the food product, e.g. a vegetarian burger, when baked is considerably less. The inventors have observed that at an ACE activity of at most 5 U/g, no significant or hardly any off taste in the baked vegetarian burger is sensed, which obviates the use of flavoring agents to mask the off taste the potato protein would conventionally have.

Alternatively or additionally, the potato protein composition has an ACE activity of at most 30 U/g, based on the dry weight of the composition. Preferably, the ACE activity is at most 20 U/g, more preferably at most 10 U/g, most preferably at most 5 U/g, based on the dry weight of the composition, and preferably at least 0.01 U/g, more preferably at least 0.05 U/g, and most preferably at least 0.1 U/g, based on the dry weight of the composition.

In still another preferred embodiment, the potato protein composition has a gel strength at a temperature of 20° C., defined as the storage modulus G′, of at least 2000 Pa, more preferably at least 3000 Pa, even more preferably at least 4000 Pa, as measured in accordance with the protocol as defined in the experimental section.

The potato protein composition of the invention can be in any form known in the art. Examples include liquids, such as dispersions, emulsions and solutions, and solids, such as granules, flakes, gels or powders.

The potato protein composition can be a potato protein concentrate or a potato protein isolate.

In a preferred embodiment, the potato protein composition comprises less than 20 wt. % of water, based on the dry weight of the composition, more preferably less than 15 wt. %, less than 10 wt. %, less than 8 wt. %, less than 6 wt. %, or less than 5 wt. %, and preferably at least 0.01 wt. % water, more preferably at least 0.1 wt. %, and most preferably at least 1 wt. %, based on the dry weight of the composition.

In an embodiment, the potato protein composition is a powder with a water content of less than 10 wt. %, preferably less than 6 wt. %, preferably less than 5 wt. %, based on the dry weight of the potato protein composition, and preferably at least 0.01 wt. % of water, more preferably at least 0.1 wt. %, and most preferably at least 1 wt. %, based on the dry weight of the composition.

In another preferred embodiment, the potato protein composition contains less than 5000 mg phenolic and/or total glycoalkaloid compounds per kg of the potato protein composition on the basis of dry weight, such as less than 4000 mg/kg, less than 3000 mg/kg, less than 2000 mg/kg, less than 1500 mg/kg, less than 1250 mg/kg, less than 1000 mg/kg, less than 750 mg/kg, less than 500 mg/kg, less than 300 mg/kg, less than 200 mg/kg, or less than 150 mg phenolic and/or total glycoalkaloid compounds/kg potato protein composition on the basis of dry weight.

In a further embodiment, the potato protein composition comprises at least 0.01 ppm glycoalkaloid, preferably at least 0.1 ppm, more preferably at least 0.5 ppm and most preferably at least 1 ppm, based on the dry weight of the composition, and preferably at most 150 ppm glycoalkaloid, more preferably at most 100 ppm, even more preferably at most 75 ppm and most preferably at most 50 ppm, based on the dry weight of the composition.

The remaining part of the potato protein composition may be comprised of other components commonly used in protein compositions, such as salts, pigments and dyes, fragrances or flavoring agents, etc. With the potato protein(s), the optional insoluble fibers and water, the other components add up to 100 wt. % of the dry weight of the composition.

### Composition Comprising Fat or Oil

In a second aspect, the invention concerns a composition comprising fat or oil comprising at least one fatty acid group having 14 carbon atoms or less, and the potato protein composition as defined hereinbefore.

The terms ‘fat’ and ‘oil’ as used herein have the generally accepted meaning in the art. Fats and oils include mixtures of mono-, di- and tri-esters of fatty acids and glycerol. Fats and oils can also comprise minor amounts of free fatty acids. The wording ‘with at least one fatty acid group having 14 carbon atoms or less’ means that the fat or oil comprises at least one ester of glycerol with a fatty acid having 14 carbon atoms or less.

The fact that the composition comprises a fat or oil with at least one fatty acid group having 14 carbon atoms or less does not mean that other fats or oils are excluded.

In an embodiment, the fat or oil is chosen from the group consisting of plant-based fat or oil, animal-derived fat or oil, and combinations thereof. Preferably, the fat or oil is plant-based fat or oil.

Preferred examples of fats or oils comprising at least one fatty acid group having 14 carbon atoms or less are plant-based fats or oils chosen from the group consisting of coconut oil, shea oil, palm kernel oil and medium chain triglycerides, and combinations thereof, more preferably plant-based fats or oils chosen from the group consisting of coconut oil, shea oil and palm kernel oil. The most preferred plant-based fat or oil is coconut oil.

In a preferred embodiment, the composition comprises at least 1 wt. % fat or oil comprising at least one fatty acid group having 14 carbon atoms, more preferably at least 5 wt. %, even more preferably at least 10 wt. %, even more preferably at least 15 wt. %, and most preferably at least 20 wt. %, based on the dry weight of the composition, and preferably at most 99 wt. % fat or oil, more preferably at most 95 wt. %, even more preferably at most 90 wt. % and most preferably at most 80 wt. %, based on the dry weight of the composition.

In a preferred embodiment, the composition comprises at least 1 wt. % potato protein composition of the invention, more preferably at least 5 wt. %, even more preferably at least 10 wt. %, even more preferably at least 15 wt. %, and most preferably at least 20 wt. %, based on the dry weight of the composition, and preferably at most 99 wt. % potato protein composition of the invention, more preferably at most 95 wt. %, even more preferably at most 90 wt. % and most preferably at most 80 wt. %, based on the dry weight of the composition.

The composition can be in any form known in the art. Examples include liquids, such as dispersions, emulsions and solutions, and solids, such as granules, flakes, gels or powders.

In an embodiment, the composition comprising fat or oil is provided as a kit of parts, wherein a first container comprises the potato protein composition as defined hereinbefore and a second container comprises the fat or oil comprising at least one fatty acid group having 14 carbon atoms or less. Both containers can comprise further ingredients, with the proviso that neither the first container nor the second container comprises both a protein with LAH activity and fat or oil comprising at least one fatty acid group having 14 carbon atoms or less.

### Food Product

In a third aspect, the invention concerns a food product comprising the potato protein composition as defined hereinbefore or the composition comprising fat or oil as defined hereinbefore. In a very preferred embodiment, the food product is a product for human consumption.

Typically, the food product comprises additional ingredients, such as one or more of water, starch, salt, flavorings, acidulants, sweeteners, preservatives, insoluble fibers, further proteins and further fats or oils.

Further fats or oils can comprise plant-based fats or oils, animal-derived fats or oils, or combinations thereof, preferably plant-based fats or oils.

Preferred examples of starch are corn starch and potato starch.

The potato protein composition can already provide the food product with insoluble fibers from potato. Other preferred sources of insoluble fibers are sugar cane fiber, soy fiber, citrus fiber and psyllium.

Further proteins can comprise further techno-functional proteins, nutritional proteins and combinations thereof. Non-limiting examples are plant-based proteins, including proteins from pulses, legumes, oilseeds, algae, kelp; proteins from microorganisms, including proteins from yeast, moulds and fungi; animal-derived protein, including whey protein, chicken protein, proteins form insects; hydrolysates thereof; textured soy protein; textured wheat protein; and combinations thereof.

Preferred examples of techno-functional plant-based proteins are canola protein, rubisco, protein from lentils, pea protein, wheat protein, gluten, protein from barley, protein from rice, soy protein, fava protein, protein from chickpeas, and combinations thereof.

In an embodiment, the food product comprises at least 0.2 wt. %, preferably between 2 and 6 wt. %, of the potato protein composition as defined hereinbefore. In another embodiment, the food product comprises at least 1 wt. %, preferably between 5 and 30 wt. %, of the composition comprising fat or oil as defined hereinbefore.

The food product can be in any form known in the art. Examples include liquids, such as dispersions, creams, emulsions and solutions, and solids, such as granules, flakes, foams, gels or powders.

In embodiments, the food product is chosen from meat or fish substitute or alternative, dairy alternative, ice cream, mayonnaise, (cream) cheese, chocolate bar, or meringue. In other embodiments, the food product is a vegetarian or vegan food product, preferably a vegetarian or vegan meat or fish substitute or alternative, dairy alternative, ice cream, mayonnaise, (cream) cheese, chocolate bar, or meringue. In other embodiments, the food product does not comprise animal-derived ingredients. In still other embodiments, the protein, fat and oil in the food product are plant-based.

In a preferred embodiment, the food product is a burger, more preferably a vegetarian or vegan burger.

In an embodiment, the raw burger, i.e. before cooking, baking and/or frying, consists of the following ingredients, based on the total weight of the burger:
between 40 and 60 wt. % of water;
between 1 and 5 wt. % of starch, preferably corn starch, potato starch, or a combination thereof;
between 0.5 and 2 wt. % of salt;
between 0.5 and 10 wt. % of insoluble fibers, preferably soy fibers, sugar cane fibers, potato fibers, citrus fibers, or a combination thereof;
between 5 and 20 wt. % of fats or oils, comprising at least one fatty acid group having 14 carbon atoms or less, preferably coconut oil, shea oil, palm kernel oil, medium-chain triglycerides, or a combination thereof;
between 1 and 6 wt. % of techno-functional protein comprising the potato protein composition as defined hereinbefore;
between 5 and 25 wt. % of nutritional protein, preferably from textured soy protein, pea protein, wheat protein, or a combination thereof; and
between 1 and 10 wt. % of further ingredients.

The burger as defined hereinbefore can be prepared by mixing the ingredients, for example at room temperature, and by using a burger press. The thus formed raw burgers can be directly baked or finish-fried for consumption or can be pre-cooked, for example for about 2 minutes at 100° C. in a steam oven, to increase preservability. The raw or pre-cooked burgers can be frozen for later use.

### Process for the Preparation of the Potato Protein Composition

In a fourth aspect, the invention concerns a method of reducing the LAH activity of a potato protein composition, said composition comprising:
patatin; and
optionally insoluble fibers from potato and/or other potato proteins;
   said method comprising the steps of:
(a) providing the potato protein composition wherein the protein, preferably the potato protein, has an aqueous solubility at pH=7.0 and 20° C. of at least 60% and wherein the composition has an acetylcholinesterase (ACE) activity of more than 30 U/g, based on the dry weight of the protein, preferably the potato protein;
(b) subjecting the potato protein composition provided in step (a) to a pH below 4.5 at a temperature below 50° C.;
(c) optionally raising the pH of the potato protein composition obtained in step (b) to a value between 5 and 10, preferably to a value between 6 and 9;
(d) optionally drying, preferably spray drying, the potato protein composition obtained in step (b) or (c).

Alternatively, the fourth aspect, can be worded as a method of reducing the LAH activity of a potato protein composition, said composition comprising:
patatin; and
optionally insoluble fibers from potato and/or other potato proteins;
   said method comprising the steps of:
(a) providing the potato protein composition wherein the protein, preferably the potato protein, has an aqueous solubility at pH=7.0 and 20° C. of at least 60% and wherein the composition has an acetylcholinesterase (ACE) activity of more than 30 U/g, based on the dry weight of the protein, preferably the potato protein;
(b) subjecting the potato protein composition provided in step (a) to a pH below 4.5 and at a temperature below 50° C.;
(c) raising the pH of the potato protein composition obtained in step (b) to a value between 5 and 10, preferably to a value between 6 and 9, to obtain a potato protein composition according to the first aspect;
(d) optionally drying, preferably spray drying, the potato protein composition obtained in step (b) or (c).

The method of reducing the LAH activity of a potato protein composition can be performed on any patatin-containing protein composition wherein the protein, preferably the potato protein, has an aqueous solubility at pH=7.0 and 20° C. of at least 60% and wherein the composition has an acetylcholinesterase (ACE) activity of more than 30 U/g, based on the dry weight of the protein, preferably the potato protein, irrespective of how this patatin-containing protein composition was obtained.

The patatin-containing protein compositions can for example be potato fruit juice with or without insoluble fibers, it can be obtained by purifying potato fruit juice with or without insoluble fibers with membrane processes, it can be obtained using expanded bed absorption processes, it can be a patatin-containing powder, etc.

In embodiments, the protein, preferably the potato protein, in the potato protein composition provided in step (a) has an aqueous solubility at pH=7.0 and 20° C. of at least 75%, at least 80%, at least 85%, or at least 90%.

In embodiments, the potato protein composition provided in step (a) has an acetylcholinesterase (ACE) activity of more than 80 U/g, based on the dry weight of the protein, preferably the potato protein, more than 100 U/g, more than 150 U/g, more than 200 U/g, more than 250 U/g, or more than 300 U/g.

In a preferred embodiment, step (c) is mandatory. In another preferred embodiment, steps (c) and (d) are mandatory.

A preferred embodiment concerns the method of reducing the ACE activity as defined hereinbefore wherein the product obtained in step (c) or (d) is a potato protein composition according to the first aspect.

In an embodiment, step (b) of the method involves subjecting the potato protein composition to a pH below 4.5, at a temperature between −10 and 50° C., such as between −5 and 40° C., or between 0 and 30° C., for a period of 5 minutes up to 24 hours, such as 10 minutes up to 12 hours, 15 minutes up to 4 hours, or 20 minutes up to 3 hours.

In another embodiment, step (b) of the method involves subjecting the potato protein composition to a pH below 4.0, at a temperature between −10 and 50° C., such as between −5 and 40° C., or between 0 and 30° C., for a period of 5 minutes up to 24 hours, such as 10 minutes up to 12 hours, 15 minutes up to 4 hours, or 20 minutes up to 3 hours.

In an embodiment, step (b) of the method involves subjecting the potato protein composition provided in step (a) to pH values between 1 and 4, such as between 1.5 and 4, between 2 and 4, between 2.5 and 4, or between 2.8 and 4, at a temperature between −10 and 50° C., such as between −5 and 40° C., or between 0 and 30° C., for a period of 5 minutes up to 24 hours, such as 10 minutes up to 12 hours, 15 minutes up to 4 hours, or 20 minutes up to 3 hours.

In another embodiment, step (b) of the method involves subjecting the potato protein composition provided in step (a) to pH values between 1 and 4, such as between 1 and 3.8, between 1 and 3.5, between 1 and 3.3, or between 1 and 3, at a temperature between 5 and 25° C. for a period of 5 minutes up to 24 hours, such as 10 minutes up to 12 hours, 15 minutes up to 4 hours, or 20 minutes up to 3 hours.

In embodiments, step (b) of the method involves adding CaCl₂ to the potato protein composition.

The method of reducing the LAH activity of a potato protein composition as defined hereinbefore is preferably part of a process comprising the steps of:
(i) providing a potato fruit juice or a derivative thereof comprising:
   patatin and further potato proteins,
   salts;
   phenolic and/or glycoalkaloid compounds; and
   optionally insoluble fibers:
(ii) subjected the potato fruit juice or the derivative thereof to a first cross-flow membrane filtration process, preferably an ultrafiltration process, wherein at least a portion of the salts and at least a portion of the phenolic and/or glycoalkaloid compounds migrate across the membrane into a first permeate and the potato proteins and the optional insoluble fibers are retained in a first retentate;
(iii) adding diafiltration liquid to the first retentate and subjecting the combined liquids to diafiltration in a second cross-flow membrane filtration process, preferably using an ultrafiltration membrane, resulting in a diafiltrate and a second retentate comprising the potato proteins and the optional insoluble fibers.

The step of reducing the LAH activity of the potato protein composition can for example be performed on the potato fruit juice or the derivative thereof provided in step (i), during the first cross-flow membrane filtration process, on the retentate resulting from the first cross-flow membrane filtration process, during the second cross-flow membrane filtration process, on the retentate of the second cross-flow membrane filtration process, on any downstream process stream comprising patatin, including a patatin-containing powder, and combinations thereof.

In a fifth aspect, the invention concerns a potato protein composition, wherein the protein, preferably the potato protein, has an aqueous solubility at pH of 7.0 and 20° C. of at least 60%, and wherein the composition has an acetylcholinesterase (ACE) activity of less than 30 U/g, based on the dry weight of the protein, preferably the potato protein, obtainable with the method of reducing the ACE activity as defined herein, wherein step (c) is mandatory.

Potato Protein Composition with Increased Concentrations of High Molecular Weight Potato Proteins (>100 kDa)

Membrane processes disclosed in the prior art to remove salts and phenolic and/or glycoalkaloid compounds from potato fruit juice typically start with a pretreatment step wherein (substantially) all of the insoluble material, including insoluble fibers, is removed prior to ultrafiltration/diafiltration, for example by pretreating the potato fruit juice causing flocculation and by subjected the potato fruit juice with flocculates to disc stack centrifuging. The inventors have found that such a pretreatment step also results in the removal of a substantial amount of valuable high molecular weight potato proteins (>100 kDa), such as polyphenol oxidase, lectin, protein kinases, phosphorylase isozymes and lipoxygenase, from the potato fruit juice. Accordingly, the purified potato protein composition obtained via such processes are devoid of or have a very low concentration of these high molecular weight potato proteins.

The present inventors have found that membrane processes, such as ultrafiltration and diafiltration, can also be applied to remove salts and phenolic and/or glycoalkaloid compounds from potato fruit that has not been subjected to a pretreatment step wherein (substantially) all of the insoluble material is removed. The purified potato protein composition obtained via such a process thus comprises insoluble fibers in addition to potato protein.

The present inventors have unexpectedly found that subsequent removal of the insoluble fibers, i.e. after membrane filtration, results in a purified potato protein composition with an increased concentration of high molecular weight potato proteins (>100 kDa), such as polyphenol oxidase, lectin, protein kinases, phosphorylase isozymes and lipoxygenase, as compared to the products obtained via prior art membrane filtration processes.

Accordingly, in a sixth aspect, the invention concerns a process for the separation of (a) potato proteins from (b) salts, insoluble fibers and phenolic and/or glycoalkaloid compounds in potato fruit juice or a derivative thereof, said method comprising the steps of:
(i) providing a potato fruit juice or a derivative thereof, comprising
   patatin, protease inhibitors and potato proteins with a molecular weight of at least 100 kDa;
   insoluble fibers;
   salts; and
   phenolic and/or glycoalkaloid compounds;
(ii) subjecting the potato fruit juice or the derivative thereof provided in step (i) to a first cross-flow membrane filtration process, preferably ultrafiltration, wherein water and at least a portion of the salts and at least a portion of the phenolic and/or glycoalkaloid compounds migrate across the membrane into a first permeate and wherein the patatin, protease inhibitors, potato proteins with a molecular weight of at least 100 kDa and insoluble fibers are retained in a first retentate;
(iii) adding aqueous diafiltration liquid, preferably containing one or more salts, to the first retentate obtained in step (ii) to form a diluted first retentate and subjecting said diluted first retentate to a second cross-flow membrane filtration as diafiltration, preferably using an ultrafiltration membrane, to create a second permeate being a diafiltrate containing at least a portion of said phenolic and/or glycoalkaloid compounds and salts and a second retentate comprising patatin, protease inhibitors, potato proteins with a molecular weight of at least 100 kDa and insoluble fibers;
(iv) optionally performing further membrane filtration steps on the second retentate resulting in a further retentate and a further permeate, said further retentate comprising patatin, protease inhibitors, potato proteins with a molecular weight of at least 100 kDa and insoluble fibers;
(v) providing the second retentate obtained in step (iii) or the further retentate obtained in step (iv) and separating the insoluble fibers from the patatin, protease inhibitors and potato proteins with a molecular weight of at least 100 kDa.

In a preferred embodiment, the amount of potato proteins with a molecular weight of 100 kDa or higher in the protein fraction obtained in step (v) is more than 1 wt. %, based on the dry weight of the potato proteins, preferably more than 2 wt. %, more preferably more than 4 wt. %, even more preferably more than 10 wt. %, even more preferably more than 12 wt. %, even more preferably more than 14 wt. %, even more preferably more than 15 wt. %, and most preferably more than 16 wt. %, and preferably less than 25 wt. %, and most preferably less than 20 wt. %.

In another preferred embodiment, the amount of potato proteins with a molecular weight of 100 kDa or higher in the inventive potato protein composition obtained in step (v) is at least 70%, preferably at least 80%, more preferably at least 85%, and most preferably at least 90%, of the amount of potato proteins with a molecular weight of 100 kDa or higher in the potato fruit juice provided in step (i), based on the dry weight of the potato proteins.

In another preferred embodiment, the amount of potato proteins with a molecular weight of 100 kDa or higher in the inventive potato protein composition obtained in step (v) is at least 70%, preferably at least 80%, more preferably at least 85%, and most preferably at least 90%, of the amount of potato proteins with a molecular weight of 100 kDa or higher in potatoes, based on the dry weight of the potato proteins.

This process preferably comprises the acid treatment step to reduce the LAH activity as defined hereinbefore.

A seventh aspect of the invention concerns the potato protein composition obtained by or obtainable by the process according to the sixth aspect. In one embodiment of the invention, the said potato protein composition comprises patatin, protease inhibitors and potato proteins with a molecular weight of at least 100 kDa,
wherein the amount of potato proteins with a molecular weight of 100 kDa or higher is more than 1 wt. %, based on the dry weight of the potato proteins in the composition, preferably more than 2 wt. %, more preferably more than 4 wt. %, even more preferably more than 10 wt. %, still more preferably more than 16 wt. %, and preferably less than 25 wt. %, more preferably less than 20 wt. %; or
wherein the wt. % of potato proteins with a molecular weight of 100 kDa or higher, based on the dry weight of the potato proteins in the composition is at least 20%, preferably at least 40%, more preferably at least 50%, even more preferably at least 70%, of the wt. % of potato proteins with a molecular weight of 100 kDa or higher, based on the dry weight of the potato proteins, in the potato fruit juice; or
wherein the wt. % of potato proteins with a molecular weight of 100 kDa or higher, based on the dry weight of the potato proteins in the composition is at least 20%, preferably at least 40%, more preferably at least 50%, even more preferably at least 70%, of the wt. % of potato proteins with a molecular weight of 100 kDa or higher, based on the dry weight of the potato proteins, in potatoes.

An eighth aspect of the invention concerns a potato protein composition comprising patatin, protease inhibitor and potato proteins with a molecular weight of at least 100 kDa, wherein the potato protein composition comprises at least 0.01 ppm glycoalkaloid, preferably at least 0.1 ppm, more preferably at least 0.5 ppm and most preferably at least 1 ppm, based on the dry weight of the composition, and preferably at most 150 ppm glycoalkaloid, more preferably at most 100 ppm, even more preferably at most 75 ppm and most preferably at most 50 ppm, based on the dry weight of the composition, and
wherein the amount of potato proteins with a molecular weight of 100 kDa or higher is more than 1 wt. %, based on the dry weight of the potato proteins, preferably more than 2 wt. %, more preferably more than 4 wt. %, even more preferably more than 10 wt. %, still more preferably more than 16 wt. %, and preferably less than 25 wt. %, more preferably less than 20 wt. %; or
wherein the wt. % of potato proteins with a molecular weight of 100 kDa or higher, based on the dry weight of the potato proteins is at least 20%, preferably at least 40%, more preferably at least 50%, even more preferably at least 70%, of the wt. % of potato proteins with a molecular weight of 100 kDa or higher, based on the dry weight of the potato proteins, in the potato fruit juice; or
wherein the wt. % of potato proteins with a molecular weight of 100 kDa or higher, based on the dry weight of the potato proteins is at least 20%, preferably at least 40%, more preferably at least 50%, even more preferably at least 70%, of the wt. % of potato proteins with a molecular weight of 100 kDa or higher, based on the dry weight of the potato proteins, in potatoes.

The patatin in the potato protein composition of the invention may also be deactivated as described above. In one embodiment, the potato protein composition has an acetylcholinesterase (ACE) activity of at most 30 U/g, more preferably at most 20 U/g, even more preferably at most 10 U/g and most preferably at most 5 U/g, based on the dry weight of the protein, preferably the potato protein, and preferably at least 0.01 U/g, more preferably at least 0.05 U/g, and most preferably at least 0.1 U/g, based on the dry weight of the protein, preferably the potato protein.

### Potato Protein Composition Comprising Patatin and Insoluble Fibers

The invention further pertains to a potato protein composition comprising patatin and insoluble fibers, wherein the amount of patatin is at least 50 wt %, based on the dry weight of the composition. These potato protein compositions generally have good techno-functional properties include a good solubility of the proteins, good emulsification and/or foaming properties and good gelling properties. These properties render these inventive compositions suitable for use in a wide variety of food products. The insoluble fibers will provide favourable dietary conditions and have the ability to improve gut health. The patatin provides good nutritional value due to the presence of essential amino acids in appropriate amounts. It is noted that the skilled person generally removes the insoluble fibers to allow for the purification of the potato proteins. The inventors have found that purification can be performed in the presence of the insoluble fibers.

In one embodiment of the invention, the composition comprises at most 150 ppm glycoalkaloid, based on the dry weight of the composition. Preferably, the inventive composition comprises at least 0.01 ppm glycoalkaloid, preferably at least 0.1 ppm, more preferably at least 0.5 ppm and most preferably at least 1 ppm, based on the dry weight of the composition, and preferably at most 125 ppm glycoalkaloid, more preferably at most 100 ppm, even more preferably at most 75 ppm and most preferably at most 50 ppm, based on the dry weight of the composition.

The inventive composition comprises patatin in an amount of at least 50 wt %. Preferably, the potato protein composition comprises at least 55 wt. % patatin, more preferably at least 60 wt. %, more preferably at least 65 wt. %, and most preferably at least 70 wt. %, based on the dry weight of the composition, and preferably at most 99 wt. % patatin, more preferably at most 95 wt. %, even more preferably at most 90 wt. % and most preferably at most 85 wt. %, based on the dry weight of the composition.

The inventive composition comprises protein, preferably potato protein, in an amount of at least 50 wt %. Preferably, the potato protein composition comprises at least 55 wt. % protein, more preferably at least 60 wt. %, more preferably at least 65 wt. %, and most preferably at least 70 wt. %, based on the dry weight of the composition, and preferably at most 99 wt. % protein, more preferably at most 95 wt. %, even more preferably at most 90 wt. % and most preferably at most 85 wt. %, based on the dry weight of the composition.

The composition of the invention further comprises insoluble fibers. Preferably, the potato protein composition comprises at least 0.4 wt. % insoluble fibers, preferably at least 0.5 wt. %, more preferably at least 1 wt. % and most preferably at least 1.5 wt. %, based on the dry weight of the composition, and preferably at most 20 wt. % insoluble fibers, more preferably at most 15 wt. %, even more preferably at most 10 wt. % and most preferably at most 5 wt. %, based on the dry weight of the composition.

The inventive composition generally comprises considerably less protease inhibitors than initially present in the potato fruit juice. In one embodiment, the amount of protease inhibitors in wt % is less than the amount of patatin in wt %, based on the dry weight of the composition. Preferably, the potato protein composition comprises at least 0.01 wt. % protease inhibitors, preferably at least 0.02 wt. %, more preferably at least 0.05 wt. % and most preferably at least 0.1 wt. %, based on the dry weight of the composition, and preferably at most 10 wt. % protease inhibitors, more preferably at most 5 wt. %, even more preferably at most 2 wt. % and most preferably at most 1 wt. %, based on the dry weight of the composition. In one embodiment, the potato protein composition is substantially free from protease inhibitors. The term “substantially free” refers to amounts of protease inhibitors that cannot be determined using conventional analytical techniques.

In an embodiment of the invention, the weight ratio of patatin and protease inhibitors in the potato protein composition is at least 1:1, more preferably at least 5:1, even more preferably at least 10:1, even more preferably at least 20:1, and most preferably at least 50:1, and preferably at most 1000:1, more preferably at most 500:1 and most preferably at most 200:1.

In a further embodiment, the potato protein composition comprises at least 0.01 wt. % potato proteins having a molecular weight above 100 kDa, preferably at least 0.1 wt. %, more preferably at least 0.5 wt. % and most preferably at least 1 wt. %, based on the dry weight of the composition, and preferably at most 40 wt. % potato proteins having a molecular weight above 100 kDa, more preferably at most 30 wt. %, even more preferably at most 25 wt. % and most preferably at most 20 wt. %, based on the dry weight of the composition. It is also contemplated that the potato protein composition of the invention is substantially free from potato proteins having a molecular weight above 100 kDa.

In a preferred embodiment, the protein, preferably the potato protein, in the composition has an aqueous solubility at pH=7.0 and 20° C. of at least 65%, more preferably at least 70%, even more preferably at least 75%, even more preferably at least 80%, and most preferably at least 85%, and preferably at most 99%, more preferably at most 98%, and most preferably at most 95%.

In another preferred embodiment, the potato protein composition has a gel strength at a temperature of 20° C., defined as the storage modulus G′, of at least 2000 Pa, more preferably at least 3000 Pa, even more preferably at least 4000 Pa, as measured in accordance with the protocol as defined in the experimental section.

In another preferred embodiment, the potato protein composition contains less than 5000 mg phenolic and/or total glycoalkaloid compounds per kg of the potato protein composition on the basis of dry weight, such as less than 4000 mg/kg, less than 3000 mg/kg, less than 2000 mg/kg, less than 1500 mg/kg, less than 1250 mg/kg, less than 1000 mg/kg, less than 750 mg/kg, less than 500 mg/kg, less than 300 mg/kg, less than 200 mg/kg, or less than 150 mg phenolic and/or total glycoalkaloid compounds/kg potato protein composition on the basis of dry weight.

The patatin in the potato protein composition of the invention may also be deactivated as described above. In one embodiment, the potato protein composition has an acetylcholinesterase (ACE) activity of at most 30 U/g, more preferably at most 20 U/g, even more preferably at most 10 U/g and most preferably at most 5 U/g, based on the dry weight of the protein, preferably the potato protein, and preferably at least 0.01 U/g, more preferably at least 0.05 U/g, and most preferably at least 0.1 U/g, based on the dry weight of the protein, preferably the potato protein.

A ninth aspect of the invention concerns a process for the separation of (a) potato proteins and insoluble fibers from (b) salts, protease inhibitors and phenolic and/or glycoalkaloid compounds in potato fruit juice or a derivative thereof, said method comprising the steps of:
(i) providing a potato fruit juice or a derivative thereof, comprising
   patatin, protease inhibitors and potato proteins with a molecular weight of at least 100 kDa;
   insoluble fibers;
   salts; and
   phenolic and/or glycoalkaloid compounds;
(ii) subjecting the potato fruit juice or the derivative thereof provided in step (i) to a first cross-flow membrane filtration process, preferably ultrafiltration, wherein water and at least a portion of the salts and at least a portion of the phenolic and/or glycoalkaloid compounds migrate across the membrane into a first permeate and wherein the patatin, protease inhibitors, potato proteins with a molecular weight of at least 100 kDa and insoluble fibers are retained in a first retentate;
(iii) adding aqueous diafiltration liquid, preferably containing one or more salts, to the first retentate obtained in step (ii) to form a diluted first retentate and subjecting said diluted first retentate to a second cross-flow membrane filtration as diafiltration, preferably using an ultrafiltration membrane, to create a second permeate being a diafiltrate containing at least a portion of said phenolic and/or glycoalkaloid compounds and salts and a second retentate comprising patatin, protease inhibitors, potato proteins with a molecular weight of at least 100 kDa and insoluble fibers;
(iv) optionally performing further membrane filtration steps on the second retentate resulting in a further retentate and a further permeate, said further retentate comprising patatin, protease inhibitors, potato proteins with a molecular weight of at least 100 kDa and insoluble fibers;
(v) providing the second retentate obtained in step (iii) or the further retentate obtained in step (iv) and separating the protease inhibitors from insoluble fibers, patatin and potato proteins with a molecular weight of at least 100 kDa, by:
   decreasing the pH of the potato juice in step (i) or the second retentate obtained in step (iii) or the further retentate obtained in step (iv) to cause precipitation of the patatin and to obtain a suspension and subjecting the resulting suspension to microfiltration resulting in a retentate comprising insoluble fibers, patatin and potato proteins with a molecular weight of at least 100 kDa and a permeate comprising protease inhibitors; or
   decreasing the pH of the potato juice in step (i) or the second retentate obtained in step (iii) or of the further retentate obtained in step (iv) to cause precipitation of the patatin, followed by centrifugation and separation of the supernatant comprising protease inhibitors from the precipitates comprising insoluble fibers, patatin and potato proteins with a molecular weight of at least 100 kDa or followed by microfiltration resulting in a retentate comprising insoluble fibers, patatin and potato proteins with a molecular weight of at least 100 kDa and a permeate comprising protease inhibitors.

This process preferably comprises the acid treatment step to reduce the LAH activity as defined hereinbefore.

A tenth aspect of the invention concerns the potato protein composition obtained by or obtainable by the process according to the ninth aspect. In one embodiment, the said potato protein composition comprises patatin, insoluble fibers and potato proteins with a molecular weight of at least 100 kDa,
wherein the amount of potato proteins with a molecular weight of 100 kDa or higher is more than 1 wt. %, based on the dry weight of the potato proteins in the composition, preferably more than 2 wt. %, more preferably more than 6 wt. %, even more preferably more than 12 wt. %, still more preferably more than 20 wt. %, and preferably less than 50 wt. %, more preferably less than 40 wt. %; or
wherein the wt. % of potato proteins with a molecular weight of 100 kDa or higher, based on the dry weight of the potato proteins in the composition is at least 20%, preferably at least 40%, more preferably at least 50%, even more preferably at least 70%, of the wt. % of potato proteins with a molecular weight of 100 kDa or higher, based on the dry weight of the potato proteins, in the potato fruit juice; or
wherein the wt. % of potato proteins with a molecular weight of 100 kDa or higher, based on the dry weight of the potato proteins in the composition is at least 20%, preferably at least 40%, more preferably at least 50%, even more preferably at least 70%, of the wt. % of potato proteins with a molecular weight of 100 kDa or higher, based on the dry weight of the potato proteins, in potatoes.

An eleventh aspect of the invention concerns a potato protein composition comprising patatin, insoluble fibers and potato proteins with a molecular weight of at least 100 kDa, wherein the weight ratio of patatin to protease inhibitors in the potato protein composition is at least 10:1, more preferably at least 20:1, even more preferably at least 30:1 and most preferably at least 50:1,
wherein the potato protein composition comprises at least 0.01 ppm glycoalkaloid, preferably at least 0.1 ppm, more preferably at least 0.5 ppm and most preferably at least 1 ppm, based on the dry weight of the composition, and preferably at most 150 ppm glycoalkaloid, more preferably at most 100 ppm, even more preferably at most 75 ppm and most preferably at most 50 ppm, based on the dry weight of the composition, and
   wherein the amount of potato proteins with a molecular weight of 100 kDa or higher is more than 1 wt. %, based on the dry weight of the potato proteins in the composition, preferably more than 2 wt. %, more preferably more than 6 wt. %, even more preferably more than 12 wt. %, still more preferably more than 20 wt. %, and preferably less than 50 wt. %, more preferably less than 40 wt. %; or
   wherein the wt. % of potato proteins with a molecular weight of 100 kDa or higher, based on the dry weight of the potato proteins in the composition is at least 20%, preferably at least 40%, more preferably at least 50%, even more preferably at least 70%, of the wt. % of potato proteins with a molecular weight of 100 kDa or higher, based on the dry weight of the potato proteins, in the potato fruit juice; or
   wherein the wt. % of potato proteins with a molecular weight of 100 kDa or higher, based on the dry weight of the potato proteins in the composition is at least 20%, preferably at least 40%, more preferably at least 50%, even more preferably at least 70%, of the wt. % of potato proteins with a molecular weight of 100 kDa or higher, based on the dry weight of the potato proteins, in potatoes.

### Examples

In the examples, the following measuring protocols were applied.

### HPLC-GPC

The amounts of patatin, protease inhibitors and further potato proteins in samples is determined via HPLC-GPC. Samples are injected into a GPC column. The type of protein can be correlated to the retention time and the amount of the specific protein to the surface area of a peak. The eluent applied is 20 mM Tris/150 mM NaCl, pH=8.0. Isocratic elution is performed. The column applied is GE Healthcare Superdex 200 Increase 10/300 GL. Detection is performed at 280 and 327 nm. The flow is 0.8 ml/min, the temperature is 30° C., the injection volume is 50 μL and the run time is 55 min.

### LC-MS

The amount of glycoalkaloids (α-solanine and α-chaconine) in samples is determined via LC-MS. Samples are injected into a LC column. The type of glycoalkaloid can be correlated to the retention time and the amount of the specific glycoalkaloid to the surface area of a peak. The eluent applied is 70%10 mM ammonium acetate (adjusted to pH=5.6 with a 5% acetic acid solution) and 30% acetonitrile. The LC-MS system applied is Agilent Technologies 6420 Triple Quad LC-MS/Agilent Poroshell 120 EC-C18 2.1×150 mm 2.7 micron (part no. 693775-902). The flow is 0.4 ml/min, the temperature is 40° C. and the injection volume is 5 μL. Samples are diluted as 5 wt. % solutions in acetic acid and filtered (0.45 μm filter) before measurement.

### Method for Measuring Gelling Behaviour and Gel Strength

The gelling behaviour and gel strength of potato protein compositions that were subjected to acidic treatment and of comparative samples that were not subjected to acidic treatment was determined using the following protocol:
(a) a sample of a potato protein composition is added to a 0.1 wt. % NaCl solution in an amount of 6 wt. %, based on the total weight of all ingredients;
(b) the potato protein sample obtained in step (a) is hydrated for 30 minutes at a temperature of 20° C. under continuous stirring;
(c) 30 ml of the sample obtained in step (b) is put into the cup (CC27) of a rheometer (Anton Paar GMBH, 302);
(d) after lowering the inner cylinder (cup bob CC27 having a diameter of 26.7 mm), the top surface of the liquid is covered with the associated lid to prevent sample dehydration during heating;
(e) the gelling behaviour is determined by heating the sample from 20° C. to 90° C. at a rate of 1° C./min, followed by a holding time of 30 minutes at 90° C. and a cooling step from 90° C. to 20° C. at a rate of 1° C./min and by measuring, during the complete cycle, visco-elastic properties at constant strain (1%) and frequency (1 Hz);
(f) after 30 min rest at 20° C., an amplitude sweep from 0.1-1000% (strain) at constant frequency (1 Hz) was performed and the value of G′ (storage modulus, Pa) at strain=1% was taken as the gel strength.
   Method for Measuring the Aqueous Solubility at pH=7.0 and T=20° C.

The aqueous solubility at pH=7.0 and at a temperature of 20° C. of protein in potato protein compositions that were subjected to acidic treatment and of comparative samples that were not subjected to acidic treatment was tested using the following protocol:
(a) a sample of potato protein composition is added to demineralized water in an amount of 5 wt. %, based on the total weight of all ingredients;
(b) the composition of step (a) is stirred for one hour at a temperature of 20° C.;
(c) the pH of the composition obtained in step (b) is measured;
(d) if the pH measured in step (c) differs from 7.0, the pH is adjusted to 7.0 with 1 M HCl or 1 M NaOH;
(e) a first subsample of the composition obtained in step (d) is taken and the total protein content (A) is determined (g/L) using the Kjeldahl method with a conversion factor of 6.25;
(f) a second subsample of the composition obtained in step (d) is taken, is centrifuged for 10 minutes at 4000 G (HERMLE Z323 centrifuge), the resulting supernatant is isolated and its total protein content (B) is determined (g/L) using the Kjeldahl method with a conversion factor of 6.25;
(g) the solubility of the potato protein composition is calculated at pH=7.0 and T=20° C. from:

Solubility=(B)/(A)·100%.

### Method for Measuring Acetylcholinesterase (ACE) Activity

The measurement of the ACE activity of potato protein compositions is based on the discoloration that occurs when acetylcholinesterase converts 1-naphthyl acetate to α-naphthol in the presence of Fast blue Salt B according to the following scheme:

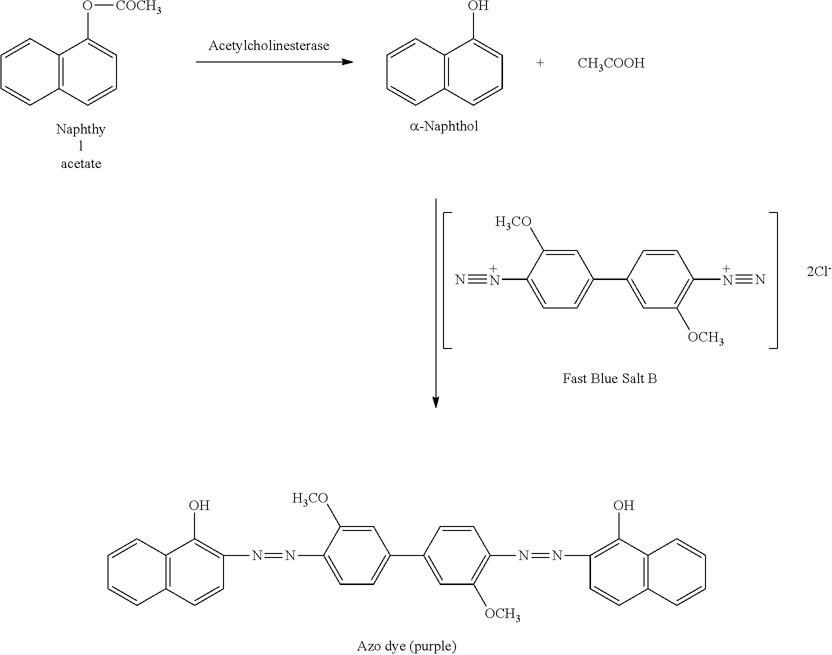

The ACE activity as used herein is expressed in units of U/g, based on the dry weight of the sample. As is known to the skilled person, one unit of ‘U’ is the amount of enzyme activity which catalyzes the transformation of 1 micromole of the substrate, i.e. 1-naphthyl acetate, per minute under standard conditions, i.e. using 15 minutes incubation time at a temperature of 20° C. and a pH of 7.5.

The following six (buffer) solutions (I) to (VI) are applied.

(I) 20 mg/ml 1-Naphthyl Acetate in 2-Propanol

This solution is produced by mixing 80 mg 1-naphthyl acetate from Sigma, USA (Cat. no.: N8505) and 4 ml of 2-propanol from VWR BDH Chemicals (Cat. no.: 20922.364). The solution can be stored in the fridge for at least a month.

### (II) 0.1 M Tris Buffer pH 7.5

This buffer solution is produced by taking 12.1 g Tris from VWR Life Science (Cat. no.: 0826), by adding 900 ml of demineralized water, by adjusting the pH to 7.5 with 4% HCl and by adding water to a final volume of 1 L.

### (III) 10% Sodium Dodecyl Sulfate (SDS)

This solution is produced by taking 10 g SDS from Sigma, USA (Cat. no.: 75746) and by adding demineralized water up to total volume of 100 ml.

(IV) Fast Blue BB Solution 6 mg/ml in 10% SDS (Colour Solution)

This solution is produced by taking 30 mg of Fast Blue BB Salt hemi(zinc chloride) from Sigma, USA (Cat. no.: 5486-84-0), by adding 5 ml 10% SDS followed by stirring gently. This solution is freshly made and kept in the dark, 5 minutes before use.

(V) 0.1533 mg/ml 1-Naphthol in 0.1 M Tris pH 7.5 (Standard Solution)

This solution is produced by taking 30 ml 0.1 M tris pH 7.5 [buffer solution (II)] and by adding 0.3 ml of 15.49 mg/ml 1-naphthol in 2-propanol, followed by mixing. This solution is fresh made, right before usage.

(VI) 0.2 mg/ml 1-Naphthyl Acetate in 0.1 M Tris pH 7.5 (Substrate Solution)

This solution is produced by taking 30 ml 0.1 M tris pH 7.5 [buffer solution (II)] and by adding 0.3 ml of 20 mg/ml 1-naphthyl acetate in 2-propanol [solution (I)], followed by mixing. This buffer is fresh made, right before usage.

In a first step, a calibration curve is made using the following steps:
(a) a dilution series of solution (V) is made;
(b) of each sample of the dilution series of step (a), 3 ml is put into separate Sarstedt polystyrene cuvets of 10×10×45 mm;
(c) 0.3 ml of buffer solution (II) is added to each cuvet and 0.42 ml of solution (IV);
(d) the contents in each cuvet are mixed, wherein the opening of the cuvet is closed with parafilm;
(e) the cuvets are left for 15 minutes at 20° C.;
(f) the absorbance of each cuvet at 510 nm, E₅₁₀, is measured with a Hach-Lange Type DR 5000 spectrophotometer;
(g) the absorbance E_{510, ref} of a cuvet with buffer solution (II) is measured as a reference (blind); and
(h) the measured absorbances for each sample of the dilution series result in the following linear calibration curve, wherein the number of micromoles of 1-naphthol formed is a function of the absorbance and wherein a and b are constants:

$${μmol}_{1 - naphthol} = a \cdot ( {E}_{510} - {E}_{510 , ref} ) + b$$

In a second step, the acetylcholinesterase (ACE) activity of potato protein compositions that were subjected to acidic treatment, of comparative samples that were not subjected to acidic treatment and of a reference (blind) is determined as follows:
(aa) a stock solution of each potato protein sample is made with a concentration of 4 mg/ml;
(bb) 0.3 ml of the stock solution obtained in step (aa), or 0.3 ml of buffer solution (II) as a reference (blind), is added to 3 ml of solution (VI) into a Sarstedt polystyrene cuvet of 10×10×45 mm;
(cc) the solution obtained in step (bb) is mixed well and incubated for exactly 15 minutes at 20° C.;
(dd) 0.42 ml of solution (IV) is added to the cuvet with the solution obtained in step (cc);
(ee) the solution obtained in step (dd) is mixed well and incubated for exactly 10 minutes;
(ff) the absorbance of each cuvet at 510 nm is measured with a Hach-Lange Type DR 5000 spectrophotometer;
(gg) the 510 nm reading from the reference (blind), E_{510, ref}, is subtracted from the 510 nm reading of the potato protein sample, E_{510, sample};
(hh) the acetylcholinesterase (ACE) activity of the sample at 20° C., pH=7.5 and at 15 minutes incubation time is calculated from:

$$A C E activity ( U / g ) = 1000 \cdot \{ a \cdot ( {E}_{510 , sample} - {E}_{510 , ref} ) + b \} {μmol}_{1 - naphthol} / ( 15 minutes \cdot 0.3 ml \cdot 4 mg / ml )$$

### Example 1: Production of Potato Protein Compositions from Potato Fruit Juice

In the following process descriptions, potato protein compositions are produced comprising patatin and protease inhibitor (PAPI) or patatin, protease inhibitor and insoluble fibers (PAPIFI) as main ingredients. Other compounds present in potato fruit juice, such as glycoalkaloids, salts and polyphenols, are removed to a large extent, but as will be appreciated by those skilled in the art, minor amounts of these compounds may still be present as impurities in the products obtained.

### Example 1a: Production of PAPI 337

Potato fruit juice (PFJ) was produced in September 2019. The PFJ was kept frozen in batches of 6 L until further use. The PFJ was thawed and 1.0 g/L sodium sulfite was added. After addition of sodium sulfite, the pH was 5.9. The thawed juice was pretreated to remove insoluble fibers by heating the PFJ to 48° C., by filtration through a plate filter pre-coated with filter aid (Perlite 30 SP) and by subsequently clarifying the filtered PFJ (until a reading of OD600<0.1 was obtained and no precipitate was observed upon centrifugation at 4000G for 30 minutes).

49 L of the thus obtained clarified PFJ was subjected to ultrafiltration at pH=5.9 on an Alfa Laval RC70PP regenerated cellulose 10 kD MWCO membrane. The PFJ was concentrated by a factor of about 8.

The resulting 6 L PFJ retentate was subjected to diafiltration at a pH of ˜7, using a solution of 0.1 M sodium chloride as diafiltration liquid A (conductivity 10 mS/cm). In total, 20 L diafiltration liquid A was added to the retentate in aliquots of 5 L. After addition of the last aliquot of 5 L diafiltration liquid A and subsequent concentration of the retentate to 6 L, the pH of the retentate was adjusted to pH 2.8 with sulfuric acid. This was followed by further diafiltration using water adjusted to pH 2.8 with sulfuric acid (diafiltration liquid B). In total, 80 L of diafiltration liquid B was added to the retentate in aliquots of 5 L. After addition of the last aliquot of 5 L diafiltration liquid B, the pH of the retentate was adjusted to pH 8.8 with sodium hydroxide, whereafter a final diafiltration step with demineralized water as diafiltration liquid was performed. In total, 15 L of water was added to the retentate in aliquots of 5 L.

The final retentate had a conductivity of 1.2 mS/cm. The final retentate was dried by freeze drying. The yield was 391 g after drying, corresponding to 8.0 g/L PFJ.

The diafiltration steps performed at pH 2.8 had a duration of approximately 3 hours. The temperature of the retentate was in the range of 23-27° C. throughout the process.

### Comparative Example 1b: Production of PAPIFI 488 and PAPI 503

Potato fruit juice (PFJ) was produced in September 2020. The PFJ was subjected to ultrafiltration to prepare a concentrate (pH 5.7) and kept frozen in batches of 6 L until further use. The PFJ concentrate was thawed and 1.0 g/L sodium sulfite was added.

To the thawed juice concentrate (5.2 kg), 5 L of a solution of 0.05 M sodium sulfate+0.5 g/L sodium sulfite (diafiltration liquid A, 8.4 mS/cm) was added. Diafiltration was carried out on an Alfa Laval RC70PP regenerated cellulose 10 kD MWCO membrane at pH 6.0. The retentate (approx. 10 L) was subjected to further diafiltration at a pH between 6.0 and 6.7, using diafiltration liquid A. In total, 110 L diafiltration liquid A was added to the retentate in aliquots of 10 L. After addition of the last aliquot of 10 L diafiltration liquid A and subsequent concentration of the retentate to 10 L, the retentate was diafiltrated further with 4×10 L demineralized water to reach a retentate having a conductivity of 0.4 mS/cm, a pH of 6.65 and a dry matter content of 7.95%. The temperature of the retentate was in the range of 23-27° C. throughout the process.

An aliquot of the retentate was adjusted to pH 8.4 and freeze dried. This product is called PAPIFI 488.

The remaining retentate was diluted 1+1 with water and sodium sulfate was added to a final concentration of 50 mM, whereafter the solution was centrifuged at 4000 RPM for 15 minutes. The supernatant was decanted and had a dry matter content of 2.9% (adjusted for the content of sodium sulfate). Thus, relative to the retentate dry matter content of 4.0% (after dilution with water) the supernatant had a yield of 2.9/4.0×100%=73% on a dry matter basis. The OD600 reading of the supernatant was 1.2.

The supernatant was then ultrafiltered and diafiltered with demineralized water on a polysulfon (PS) hollow fiber membrane from Koch with a molecular weight cut-off of 30 kDa until the retentate had a conductivity of 0.7 mS and a pH of 6.3, followed by freeze drying. This product is called PAPI 503.

### Example 1c: Production of PAPIFI 549

Potato fruit juice (PFJ) was produced on Feb. 10, 2021. The resulting PFJ was kept frozen in the freezer in batches of 6 L until further use. Prior to the test, the PFJ was thawed and 1.0 g/L sodium sulfite was added. No further pretreatment was performed.

30 L of the resulting PFJ was subjected to ultrafiltration at pH 5.9. Ultrafiltration was carried out on a polysulfon (PS) hollow fiber membrane from Koch with a molecular weight cut-off of 50 kDa. The PFJ was concentrated by a factor of 5.

The resulting 6 L PFJ retentate was subjected to diafiltration at a pH slightly above 6 using a solution of 3 g/L sodium sulfite as diafiltration liquid A. The conductivity of this solution was 4.1 mS/cm. In total, 36 L diafiltration liquid A was added to the retentate in aliquots of 6 L. After addition of the last aliquot of 6 L diafiltration liquid A and subsequent concentration of the retentate to 6 L, the pH of the retentate was adjusted to pH 3.0 with sulfuric acid. This was followed by further diafiltration using a 25 mM sodium sulfate solution adjusted to pH 3 with sulfuric acid and having a conductivity of 4.5 mS/cm (diafiltration liquid B). In total, 36 L of diafiltration liquid B was added to the retentate in aliquots of 6 L. After addition of the last aliquot of 6 L diafiltration liquid B and again concentrating the retentate to 6 L, the pH of the retentate was adjusted to pH 8.5 with sodium hydroxide, whereafter a final diafiltration step using demineralized water as diafiltration liquid was performed to reach a final conductivity of the retentate of 1.4 mS/cm and a pH=8.2.

The final retentate was dried by freeze drying and was called PAPIFI 549. The diafiltration steps performed at pH 3.0 had a duration of approximately 1.5 hours. The temperature of the retentate was in the range of 13-15° C. throughout the process.

### Example 1d: Production of PAPIFI 572

Potato fruit juice (PFJ) was produced on Feb. 10, 2021. The resulting PFJ was kept frozen in the freezer in batches of 6 L until further use. Prior to the test, the PFJ was thawed and 1.0 g/L sodium sulfite was added. No further pretreatment was performed.

39 L of the resulting PFJ was subjected to ultrafiltration at pH 5.9. Ultrafiltration was carried out on a polysulfon (PS) hollow fiber membrane from Koch with a molecular weight cut-off of 30 kDa. The PFJ was concentrated by a factor of 5.

The resulting 8 L PFJ retentate was subjected to diafiltration at a pH slightly above 6 using a solution of 3 g/L sodium sulfite as diafiltration liquid A. The conductivity of this solution was 4.1 mS/cm. In total, 48 L diafiltration liquid A was added to the retentate in aliquots of 8 L. After addition of the last aliquot of 8 L diafiltration liquid A and again concentrating the retentate to 8 L, the pH of the retentate was adjusted to pH 3.0 with sulfuric acid. This was followed by further diafiltration using a 25 mM sodium sulfate solution adjusted to pH 3.3 with sulfuric acid and having a conductivity of 4.5 mS/cm (diafiltration liquid B). In total, 48 L of diafiltration liquid B was added to the retentate in aliquots of 8 L. After addition of the last aliquot of 8 L diafiltration liquid B and again concentrating the retentate to 8 L, the pH of the retentate was adjusted to pH 8.5 with sodium hydroxide, whereafter a final diafiltration step using demineralized water as diafiltration liquid (3×8 L) was performed to reach a final conductivity of the retentate of <1 mS/cm.

The final retentate was dried by freeze drying and was called PAPIFI 572. The diafiltration steps performed at pH 3.0 had a duration of approximately 2 hours. The temperature of the retentate was approximately 18° C. throughout the process.

### Comparative Example 1e: Production of PAPIFI 588

Potato fruit juice (PFJ) was produced in July 2021. The PFJ was kept frozen in the freezer in batches of 6 L until further use. Prior to the test, the PFJ was thawed and 2.0 g/L sodium sulfite was added and the pH was adjusted to pH 5.5 with sulfuric acid. No further pretreatment was performed.

24.4 L of the resulting PFJ was subjected to ultrafiltration. Ultrafiltration was carried out on a polysulfon (PS) hollow fiber membrane from Koch with a molecular weight cut-off of 30 kDa. The PFJ was concentrated by a factor 3.7.

The resulting 6.7 L PFJ retentate was subjected to diafiltration at a pH slightly above 6 using a solution of 25 mM sodium sulfate as diafiltration liquid A. The conductivity of this solution was 4.5 mS/cm. In total, 80 L diafiltration liquid A was added to the retentate in aliquots of 6.7 L. After addition of the last aliquot of 6.7 L diafiltration liquid A and again concentrating to 6.7 L, 6.7 L demineralized water was added to the retentate and the pH of the retentate was adjusted to pH 8.4 with sodium hydroxide. The retentate was again concentrated to 6.7 L, whereafter a final diafiltration step using demineralized water as diafiltration liquid (3×6.7 L) was performed to reach a final conductivity of the retentate of <1 mS/cm.

The final retentate was dried by freeze drying and was called PAPIFI 588. The temperature of the retentate was in the range of 20-25° C. throughout the process.

### Example 1f: Production of PAPIFI 591

Potato fruit juice (PFJ) was produced in July 2021. The PFJ was kept frozen in the freezer in batches of 6 L until further use. Prior to the test, the PFJ was thawed and 2.0 g/L sodium sulfite was added. No further pretreatment was performed.

23 L of PFJ was subjected to ultrafiltration at pH 5.9. Ultrafiltration was carried out on a polysulfon (PS) hollow fiber membrane from Koch with a molecular weight cut-off of 30 kDa. The PFJ was concentrated by a factor 4.6.

The resulting 5 L PFJ retentate was subjected to diafiltration at a pH slightly above 6 using a solution of 5 mM calcium chloride as diafiltration liquid A. The conductivity of this solution was 1.1 mS/cm. In total, 15 L diafiltration liquid A was added to the retentate in aliquots of 5 L.

After addition of the last aliquot of 5 L diafiltration liquid A and again concentrating to 5 L, the pH of the retentate was adjusted to pH 3.0 with sulfuric acid. This was followed by further diafiltration using a 5 mM calcium chloride solution adjusted to pH 3.0 with sulfuric acid and a conductivity of 1.2 mS/cm (diafiltration liquid B). In total, 45 L of diafiltration liquid B was added to the retentate in aliquots of 5 L.

The resulting retentate was again concentrated to 5 L. The pH was adjusted to pH 8.4, whereafter a final diafiltration step using demineralized water as diafiltration liquid (4×5 L) was performed to reach a final conductivity of the retentate of 1.2 mS/cm.

The final retentate was dried by freeze drying.

The diafiltration steps performed at pH 3.0 had a duration of 1 hour. The temperature of the retentate was in the range of 20-25° C. during all steps.

### Example 1g: Production of PAPIFI 598

This example concerns a repetition of Example 1f.

### Example 1h: Treatment of Solanic 200®

Solanic 200® was obtained from Avebe, The Netherlands. Solanic 200® is a potato protein composition, isolated from potato fruit juice, mainly comprising patatin.

Solanic 200® was subjected to acid treatment (15 minutes) by:
(a) preparing a sample of 8 wt. % Solanic 200® in demineralized water, based on the dry weight of the composition;
(b) adjusting the pH of the sample obtained in step (a) with HCl to pH 3;
(c) leaving the sample obtained in step (b) at pH 3 and at a temperature of 20° C. for 15 minutes;
(d) measuring the ACE activity of the sample obtained in step (c);
(e) adjusting the pH of the samples obtained in step (c) to pH 8 using NaOH; and
(f) subjecting the samples obtained in step (e) to freeze drying.

### Example 1i: Ultrafiltration and Diafiltration of Potato Fruit Juice with an Integrated Step for Inactivation of Enzymatic Activity

30 L potato fruit juice, produced without any further pretreatment, was subjected to ultrafiltration and diafiltration to clarify the potato fruit juice. The potato fruit juice, having a true protein concentration of 11.5 g/l, had a pH of 6.0 and a conductivity of 13.1 mS/cm. When the potato fruit juice was diluted with water to a 5 mg/ml true protein concentration and centrifuged in a tabletop centrifuge at 4000 G for 30 min, there remained a pellet constituting approximately 1 vol/vol % of the potato fruit juice volume. Accordingly, the potato fruit juice comprised a considerable amount of insoluble fibers. O.D. 600 nm of the potato fruit juice was 2.0 (measured as diluted 3× in 50 mM potassium phosphate, at pH 7.0. The resulting absorbance reading was multiplied by 3).

The retentate obtained after a first diafiltration step was subjected to an enzyme inactivation step, followed by further diafiltration, solubilization and final purification of the resulting protein product.

### Ultrafiltration

The procedure was as follows: a 3 inch ROMICON PM30, 1.1 mm i.d. (Koch Membrane Systems, USA) hollow fiber membrane unit was employed. This unit has a membrane area of 2.3 m². The cross flow was set at 34 L/min and the TMP (transmembrane pressure) was regulated to be approximately 1.2 bar.

The 30 L potato fruit juice was concentrated using ultrafiltration to a retentate volume of 6 L (i.e. the concentration factor was 5×) and the 24 L clear purple/brown permeate (labelled ‘first permeate’) was collected and stored at 2-4° C. until further processing. Using the built-in heat exchanger of the equipment, the temperature of the retentate (labelled ‘first retentate’) was kept in the range of 20-25° C. during the entire ultrafiltration procedure.

The flux observed in the beginning of the ultrafiltration process was approximately 35 LMH and thereafter gradually decreased to 15 LMH when the retentate was 5× concentrated. There were no signs of membrane fiber clogging due the high content of insoluble material (insoluble fibers).

### Diafiltration

Following the 5× concentration using ultrafiltration, 6 L, 3 g/L sodium sulfite was added to the first retentate (Sigma Aldrich USA, cat. No.: 13471), conductivity=4.1 mS/cm at 18° C., followed by further ultrafiltration to again reduce the retentate volume to 6 L while the corresponding permeate was collected in a separate vessel labelled ‘diafiltrate’. This procedure was repeated in total 6 times such that in total 36 L diafiltrate was obtained. The retentate was labelled ‘retentate’.

A sample of the ‘retentate’ obtained after diafiltration was diluted 20 times in 50 mM potassium phosphate at pH 7.0 and the O.D. 600 of the diluted sample was measured to be 0.6. Thus, the undiluted retentate had an O.D. 600 nm of 20×0.6=12. The undiluted retentate had a pH value of 7.7.

During diafiltration, a gradual increase of flux was observed and at the final stages the flux was in the range of 22 LMH when a 6 L diafiltration portion was added. This correlated well with a gradual increase of pH in the retentate for each diafiltration step added which initially had a pH of 5.9 and at the end of this first diafiltration with sodium sulfite had a pH of 7.7.

Analysis of the first 6×6 L diafiltration permeate for alkaline colored phenols showed that the concentration of phenols was very high in the first permeate fractions and then gradually decreased for each 6 L permeate fraction. The sixth permeate fraction was estimated to contain less than 10% of the initial permeates. Also, the majority of the glycoalkaloids were analyzed to be in the first six permeate fractions, although still a significant concentration was also found in the subsequent fractions.

### Inactivation of Enzyme Activity, Further Diafiltration, pH Adjustment and Final Diafiltration

A 20 ml sample of the retentate obtained after the first diafiltration step was divided into two aliquots which were adjusted with sulfuric acid to a pH of 4.0 and 3.0, respectively. The two solutions were then again divided into two aliquots which were incubated at room temperature (RT, 20-23° C.) and 40° C., respectively, for 3 hrs. During the incubation, samples for analysis of esterase activity were withdrawn, neutralized with sodium hydroxide and analyzed for esterase activity.

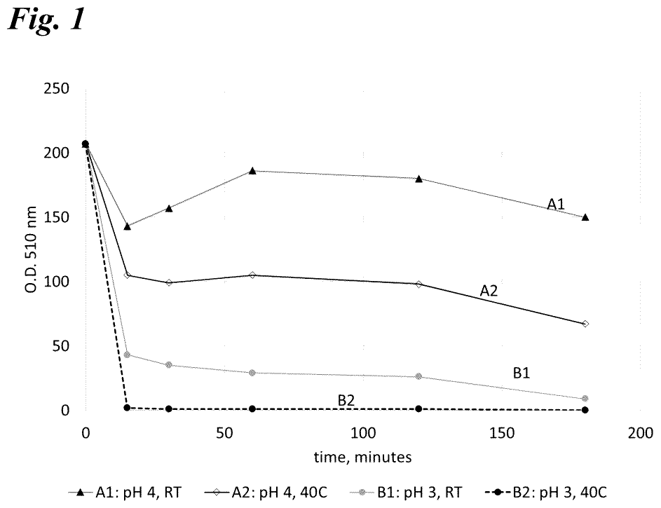

FIG. 1 shows the esterase activity signal (O.D.510 nm) in the different samples as a function of incubation time at pH 4.0 and pH 3.0, respectively. FIG. 1 shows that the esterase activity in the retentate sample is reduced when incubated at pH 4.0 or 3.0 at room temperature. At pH 3, the esterase activity signal at 510 nm decreases strongly over time and after 3 hrs., it is reduced with a factor of 24. When the temperature is increased to 40° C., the inactivation is very effective even after 15 minutes, after which the esterase activity is reduced with a factor of 98. At room temperature and pH 3.0, it is observed that an activity drop of about 85% is reached after about 1 hour and that this level is rather constant until up to about 2 hours after incubation. From a process robustness perspective, it may be preferable to have ample time to perform the operations without changes of the process outcome and it was therefore chosen to perform the next preparative steps at pH 3.0 and room temperature.

### Preparative Inactivation Procedure and Subsequent Solubilization

The retentate after diafiltration was kept in the membrane filtration unit and 6 L, 20 mM sodium sulfate was added (SL 99.8% from Lenzing, Austria adjusted to pH 3.3 with sulfuric acid, conductivity=3.8 mS/cm at 20° C.). Thereafter, the pH was adjusted to 3.0 with sulfuric acid while recirculating in the membrane filtration unit using the built-in heat exchanger to keep the temperature in the range of 20-25° C. Following recirculation for 15 minutes, the retentate was then again concentrated to a volume of 6 L retentate. The permeate was collected and labelled ‘acidic permeate’ and stored at 2-4° C. Following the concentration, again 6 L, 20 mM sodium sulfate, pH 3.3, was added to the retentate. This procedure was repeated in total 6 times, such that in total 42 L acidic permeate was obtained.

To the retentate was then added 6 L water and the pH was adjusted to pH 8.5 with sodium hydroxide while the retentate was kept in the membrane filtration unit under recirculation. A total of 2 hours at 20-25° C. was passing from the time the retentate was adjusted to pH 3.0 and until the pH was raised again to pH 8.5. The retentate was then again concentrated to a volume of 6 L retentate. The permeate was collected and labelled ‘final permeate’ and stored at 2-4° C. Following the concentration, 6 L of water was added to the retentate. This procedure was repeated in total 3 times such that in total 24 L final permeate was obtained. The retentate was collected from the membrane filtration unit in a volume of 5.8 L and labelled ‘final retentate’.

The conductivity of the final retentate was 0.8 mS (at 20° C.). The pH was 7.9. The dry matter concentration of the final retentate was 6.5%, corresponding to a total yield of dry matter of 377 g. The protein purity was determined by Kjeldahl analysis to be 89% and the total glycoalkaloid content was determined to be 25 mg/kg protein (on a dry matter basis). Testing for alkaline colored phenolic compounds gave no visible reaction, indicating that practically all phenolic compounds were removed.

When the final retentate was diluted to a true protein concentration equal to the potato fruit juice (11.5 g/L) and was analyzed for esterase activity, it was found that the activity signal was reduced with approximately 85%. Likewise, when performing a determination of polyphenol oxidase (PPO) activity, no visible reaction was observed, indicating that practically all the PPO activity was eliminated.

A sample of the final retentate was diluted 20 times in 50 mM potassium phosphate at pH 7.0 and the O.D. 600 of the diluted sample was measured to be 0.55. Thus, the undiluted final retentate had an O.D. 600 nm of 20×0.55=11. Accordingly, the final retentate comprised a considerable amount of insoluble fibers.

When diluted to a dry matter concentration of 0.5% in water and after centrifugation for 30 minutes at 4000 G, there was less than 1 vol/vol % pellet. The dry matter of the supernatant was still close to 0.5% indicating a more than 90% solubility of the potato protein product. The resulting potato protein composition is a composition comprising patatin and protease inhibitor without the insoluble fibers in accordance with the invention. This is in sharp contrast to prior art reports indicating that treatment of potato fruit juice at low pH leads to significant loss of solubility, and thereby functionality.

### Example 1j: Potato Protein Composition Comprising Patatin and Protease Inhibitor

The same procedure was followed as for Example 1i, except that the deactivation was not performed. The obtained retentate is subsequently diluted to a dry matter concentration of 0.5% in water and after centrifugation for 30 minutes at 4000 G, there was less than 1 vol/vol % pellet. The dry matter of the supernatant was still close to 0.5% indicating a more than 90% solubility of the potato protein product. The resulting potato protein composition is a composition comprising patatin and protease inhibitor without the insoluble fibers in accordance with the invention.

### Example 1k: Potato Protein Composition Comprising Patatin and Insoluble Fibers

To 1600 ml potato fruit juice is added calcium chloride to a final concentration of 20 mM and di-Sodium-hydrogen-phosphate to a final concentration of 10 mM, the pH is adjusted to 7.5 with 1 M NaOH. The resulting suspension is incubated for 5 min, whereafter the pH is adjusted to 2.7 with 10% sulfuric acid. Subsequently, the suspension is centrifuged (3 min at 1430 G). The supernatant containing protease inhibitors was decanted, and the filter cake contained patatin and insoluble fibers was loaded onto a microfiltration unit with a 0.2 pm hollow fiber membrane (Spectrum Labs, USA cat. no.: S02-P20U-10N). Cross flow is 1.2 L/min. During the initial concentration the permeate is collected in fractions of 466 ml (test solutions 4 through 6). When 200 ml retentate is remaining, 200 ml of 0.1 M NaCl is added to wash the retentate (dialfiltration). 200 ml of permeate is then collected. This procedure is performed four more times resulting in four additional permeate fractions. Then 200 ml of water is added to the retentate to wash (diafiltration) it further. Then 200 ml of permeate is collected. This procedure is performed four more times resulting in four additional permeate fractions. The pH in the retentate is adjusted to 9.2 and drained from the microfiltration unit and freeze dried. The resulting solids contained predominantly patatin and insoluble fibers.

The average flux of the microfiltration process was 32 L/hr/m² and no clogging of the hollow fibers was observed.

### Example 2: Enzymatic Activity and Functionality of Potato Protein Compositions

ACE activity, aqueous solubility and gelling behaviour of the different potato protein compositions obtained in Examples 1a-1g and of Solanic® 200 potato protein as obtained in Example 1h, were measured using the protocols as defined hereinbefore. The ACE activity of Solanic® 200 subjected to acid treatment in Example 1h was measured before adjusting the pH to 8 and before subjecting the samples to freeze drying.

Results are presented in Table 1, along with the protein content (Kjeldahl %) and the process conditions applied during the acid treatment step.

TABLE 1

| | | | | | | ACE | | | |
|---|---|---|---|---|---|---|---|---|---|
| | | | | | | Activity | ACE | | |
| | | Acid | Protein | Dry | ACE | (U/g | Activity | | Storage |
| | | treatment | Kjeldahl | matter | Activity | dry | (U/g | Solubility | modulus |
| Example | Sample | conditions | (%) | (wt. %) | (U/g) | matter) | protein) | (%) | G′ (Pa) |
| Ex 1a | PAPI | pH 2.8; 23-27° C.; | 91 | 95.9 | 1 | 1 | 1 | ** | 4771 |
| | 337 | 3 hrs | | | | | | | |
| Ex 1b | PAPI | No treatment | 87 | 93.3 | 110 | 118 | 126 | ** | 4490 |
| | 503 | | | | | | | | |
| Ex 1c | PAPIFI | pH 3.0; 13-15° C.; | 85 | 97.5 | 17 | 17 | 20 | ** | 7086 |
| | 549 | 1.5 hrs | | | | | | | |
| Ex 1d | PAPIFI | pH 3.0; 18° C.; | 88 | 97.5 | 15 | 15 | 17 | 86 | 5462 |
| | 572 | 2 hrs | | | | | | | |
| Ex 1e | PAPIFI | No treatment | 86 | 95* | 104 | 109 | 121 | 80 | 6772 |
| | 588 | | | | | | | | |
| Ex 1f | PAPIFI | pH 3; 60 min.; 20- | 85 | 95* | 7 | 7 | 8 | 90 | 6792 |
| | 591 | 25° C.; CaCl₂ | | | | | | | |
| Ex 1g | PAPIFI | pH 3; 60 min.; 20- | 85 | 95* | 2 | 2 | 2 | 94 | 8464 |
| | 598 | 25° C.; CaCl₂ | | | | | | | |
| Ex 1h | Solanic ® | No treatment | 87 | 95* | 97 | 102 | 111 | 98 | 6067 |
| | 200 | | | | | | | | |
| Ex 1h | Solanic ® | pH 3; 15 min; 20° C. | 87 | 95* | 20 | 21 | 23 | ** | ** |
| | 200 | | | | | | | | |

*estimates
(**) not determined

As can be concluded from Table 1, an acid treatment step at appropriate conditions can lead to a substantial reduction of the ACE activity, and thus the LAH activity, without substantially affecting the functional properties of the potato protein compositions, such as aqueous solubility and gel strength.

### Example 3: Production of Plant-Based Burgers with Potato Protein Compositions

Plant-based burgers were produced with the different potato protein compositions obtained in Example 1 and with commercial Solanic® 200 potato protein from Avebe, Netherlands. The general recipe for the plant-based burgers is given in Table 2.

TABLE 2

| Ingredients | Label | Supplier | Article number | wt. % |
|---|---|---|---|---|
| Soy texturate (TVP) | A | FMA | Response 4410 | 22.50 |
| Water | A | | tap water | 28.50 |
| Potato starch (native) | C | Duynie | Novidon | 1.50 |
| Corn starch | C | Cargill | Native C*Gel 03401 | 1.50 |
| Psyllium | C | Brenntag | Psyllium seed | 1.30 |
| | | | husk powder | |
| Salt | C | AkzoNobel | JOZO puur salt | 1.40 |
| | | | with jodium fine | |
| Dextrose | C | Cargill | C*Dex 02043 | 0.50 |
| Water | B | | tap water | 27.20 |
| Potato protein comp. | B | | | 3.50 |
| Lactic acid | D | Boom b.v | Liquid 88% pure | 0.10 |
| Sugar cane fibre | E | CFF GmbH&Co KG | Sanacel SC40 | 3.00 |
| Coconut oil | E | AAK | CNO 16-001 | 9.00 |
| Total | | | | 100.00 |

The plant-based burgers were produced using the following order of steps (see the label in Table 2 for the specific ingredients):
(i) blend ingredients (A) for 30 minutes at about 20° C.;
(ii) blend ingredients (B) for 30 minutes at about 20° C.;
(iii) mix the blends obtained in step (i) and (ii) in a Hobart mixer (position 1, K-blade) for 5 minutes at about 20° C.;
(iv) add ingredients (C) to the mixture in the Hobart mixer obtained in step (iii) and mix for 5 minutes at about 20° C.;
(v) add ingredient (D) to the mixture in the Hobart mixer obtained in step (iv) and mix for 2 minutes at about 20° C.;
(vi) add ingredients (E) to the mixture in the Hobart mixer obtained in step (v) and mix for 2 minutes at about 20° C.;
(vii) form burgers of approximately 115 g from the mixture obtained in step (vi) in a burgerpress (Sammic S. L., Ø 10 cm) at about 20° C.;
(viii) pre-cook the burgers obtained in step (vii) in a steam-oven (Convotherm OEB.6.10) for 2 minutes at 100° C.;
(ix) cool the pre-cooked burgers obtained in step (viii) in a blast freezer (Foster BFT38), position hard for 20 minutes; and
(x) finish-fry the burgers obtained in step (ix) in a frying pan on an induction hob (ATAG) position 7, each side for 2.5 minutes.

### Example 4: Sensory Assessment of Plant-Based Burgers

The burgers prepared in Example 3 were sensory evaluated by a trained panel of 5 persons and scored on flavour/taste and structure/bite. The results are presented in Table 3.

It can be concluded from Table 3 that the potato protein compositions that were subjected to an acid treatment step could be used to produce good/firm burgers with improved flavour as compared to burgers based on potato protein compositions that were not subjected to an acid treatment and had considerable LAH activity.

TABLE 3

| Potato | ACE Activity | | Storage | | | | |
|---|---|---|---|---|---|---|---|
| protein from | (U/g dry | ACE Activity | modulus G′ | Smell during | | Description | |
| Example | matter) | (U/g protein) | (Pa) | baking | Flavor | flavor | Texture |
| Ex 1a | 1 | 1 | 4771 | neutral | +/− | potato | good, firm |
| Ex 1b | 118 | 126 | 4490 | soapy | ++++ | chemical, soap | good, firm |
| Ex 1c | 17 | 20 | 7086 | a bit soapy | +(+) | a bit soapy | a bit firm |
| Ex 1d | 15 | 17 | 5462 | neutral/cardbord | + | slight off taste | a bit dry, |
| | | | | | | | firm |
| Ex 1e | 109 | 121 | 6772 | soapy | ++++ | very rancid/ | spat out, |
| | | | | | | soapy/bitter | softer |
| Ex 1f | 7 | 8 | 6792 | a bit soapy | +(+) | a bit soapy | good, firm |
| Ex 1g | 2 | 2 | 8464 | soy, cardbord | +/− | soy | bit firm, |
| | | | | | | | mushy |
| Ex 1h | 102 | 111 | 6067 | soapy | ++++ | very rancid/ | good, firm |
| | | | | | | soapy/bitter | |

+'s means degree of ‘off flavor’:
+/− = neutral;
+ = light off-taste/soapy;
+++++ = very bad off-taste/chemical/soapy

1.-15. (canceled)

16. Potato protein composition comprising:
patatin; and
optionally insoluble fibers from potato and/or other potato proteins,
wherein the protein, preferably the potato protein, has an aqueous solubility at pH=7.0 and 20° C. of at least 60%, and
wherein the composition has an acetylcholinesterase (ACE) activity of less than 30 U/g, based on the dry weight of the protein.

17. The potato protein composition according to claim 16, wherein the composition has an acetylcholinesterase (ACE) activity of less than 30 U/g, based on the dry weight of the potato protein.

18. The potato protein composition according to claim 16, wherein the composition comprises at least 10 wt. % protein, based on the dry weight of the composition.

19. The potato protein composition according to claim 18 wherein the composition comprises at least 10 wt. % potato protein, based on the dry weight of the composition.

20. The potato protein composition according to claim 16, having an ACE activity of less than 20 U/g, based on the dry weight of the protein.

21. The potato protein composition according to claim 20, having an ACE activity of less than 10 U/g based on the dry weight of the protein.

22. The potato protein composition according to claim 20, having an ACE activity of less than 20 U/g based on the dry weight of the potato protein.

23. The potato protein composition according to claim 16, wherein the protein has an aqueous solubility at pH=7.0 and 20° C. of at least 65%.

24. The potato protein composition according to claim 23, wherein the protein has an aqueous solubility at pH=7.0 and 20° C. of at least 85%.

25. The potato protein composition according to claim 23, wherein the potato protein has an aqueous solubility at pH=7.0 and 20° C. of at least 65%.

26. The potato protein composition according to claim 16, wherein the potato protein composition has a gel strength at a temperature of 20° C., defined as the storage modulus G′, of at least 2000 Pa as measured in accordance with the protocol as defined in the detailed description.

27. The potato protein composition according to claim 16, wherein the potato protein composition has a gel strength at a temperature of 20° C., defined as the storage modulus G′, of at least 4000 Pa as measured in accordance with the protocol as defined in the detailed description.

28. A food product comprising the potato protein composition of claim 16.

29. The food product according to claim 28, wherein the food product is chosen from meat or fish substitute or alternative, dairy alternative, ice cream, mayonnaise, (cream) cheese, chocolate bar and meringue.

30. The food product according to claim 28, wherein the food product is vegetarian or vegan.

31. A method of reducing the lipolytic acyl hydrolase (LAH) activity of a potato protein composition, said composition comprising:
patatin; and
optionally insoluble fibers from potato and/or other potato proteins;
said method comprising the steps of:
(a) providing the potato protein composition wherein the potato protein has an aqueous solubility at pH=7.0 and 20° C. of at least 60% and wherein the composition has an acetylcholinesterase (ACE) activity of more than 30 U/g, based on the dry weight of the potato protein;
(b) subjecting the potato protein composition provided in step (a) to a pH below 4.5 at a temperature below 50° C.;
(c) optionally raising the pH of the potato protein composition obtained in step (b) to a value between 5 and 10;
(d) optionally drying the potato protein composition obtained in step (b) or (c).

32. The method according to claim 31, wherein step (c) is mandatory.

33. The method according to claim 31, wherein step (d) comprises spray drying the potato protein composition obtained in step (b) or (c).

34. The method according to claim 31, wherein the product obtained in step (c) or (d) is a potato protein composition comprising
patatin; and
optionally insoluble fibers from potato and/or other potato proteins,
wherein the protein, preferably the potato protein, has an aqueous solubility at pH=7.0 and 20° C. of at least 60%, and
wherein the composition has an acetylcholinesterase (ACE) activity of less than 30 U/g, based on the dry weight of the protein.
